(19) United States
(12) Patent Application Publication
(10) Pub. No.: US 2023/0421093 A1
(43) Pub. Date: Dec. 28, 2023

(54) TRACKER CONTROLLER FOR A PHOTOVOLTAIC INSTALLATION

(71) Applicant: SOLTEC INNOVATIONS, S.L., Molina de Segura (ES)

(72) Inventors: Samir CHAOUKI ALMAGRO, Molina de Segura (ES); Santiago GARCÍA CAPITÁN, Molina de Segura (ES)

(73) Assignee: SOLTEC INNOVATIONS, S.L., Molina de Segura (ES)

(21) Appl. No.: 18/037,034

(22) PCT Filed: Nov. 16, 2021
(86) PCT No.: PCT/EP2021/081816

§ 371 Date: May 15, 2023

(30) Foreign Application Priority Data
Nov. 23, 2020 (EP) 20383018.7

(51) Int. Cl. H02S 20/32; H01Q 1/12; F24S 50/20

(52) U.S. Cl. CPC H02S 20/32; F24S 50/20; H01Q 1/12

(57) ABSTRACT

A tracker controller for a photovoltaic installation includes a box and an antenna for a communications system housed within the box, with: an elongated casing pipe and a connection at one end of the casing pipe, connecting the casing pipe to a lower portion of the box, for the casing pipe to freely rotate with respect to the box around a rotation axis. The antenna also includes a protrusion, extending from the casing pipe near the connection, and which is configured so as to bump against the box, when the antenna rotates, for limiting rotation of the casing pipe, so that the antenna stays essentially in a vertical orientation.

### CROSS-REFERENCE TO RELATED APPLICATIONS

This application is a national stage under 35 U.S.C. § 371 of PCT patent application PCT/EP2021/081816 filed on 16 Nov. 2021, which is pending and which is hereby incorporated by reference in its entirety for all purposes. PCT/EP2021/081816 claims priority to European Patent Application 20383018.7 filed 23 Nov. 2020, which is hereby incorporated by reference in its entirety for all purposes.

### TECHNICAL FIELD OF THE INVENTION

The present invention belongs to the technical field of solar energy, in particular to solar trackers, for providing rotation to a module of solar panels for sun-tracking. More particularly, the object of the invention relates to a tracker controller for a solar installation comprising an external antenna which is easily orientable in vertical direction.

### BACKGROUND OF THE INVENTION (STATE OF THE ART)

A solar tracker of a photovoltaic installation comprises a controller. The controller comprises a box and a communications system housed within the box. An external antenna may be externally attached to the box of the controller.

It is known that the antenna provides an optimized electromagnetic radiation spectrum when the antenna is oriented in vertical direction pointing downwards.

However, the movement of the tracker and the effect of the wind negatively affect the orientation of the antenna.

### SUMMARIZED DESCRIPTION OF THE INVENTION

The tracker controller of the present invention allows, as will be explained below, the external antenna to stay in a vertical orientation pointing downwards, irrespective of the angular position of the solar tracker and the speed of wind, according to the independent claim. The dependent claims describe preferred embodiments of the invention.

### BRIEF DESCRIPTION OF THE DRAWINGS

The advantages mentioned above, as well as other advantages and features of the present invention, shall be better understood with reference to the following detailed description of a preferred embodiment of the invention, with due regard to the attached set of figures, which are to be construed in an illustrative, non-limitative manner, and wherein:

FIG. 1 shows a schematic side view of a photovoltaic installation comprising the tracker controller of the present invention.

FIG. 2 shows a detailed side view of the antenna making part of the tracker controller.

FIGS. 3A and 3B show the antenna with the protrusion thereof bumping against the box, both in front view (see FIG. 3A) and in rear view (see FIG. 3B).

FIG. 4 shows a detailed side view of the protrusion of the antenna bumping against the box.

### DETAILED DESCRIPTION OF A PREFERRED EMBODIMENT OF THE INVENTION

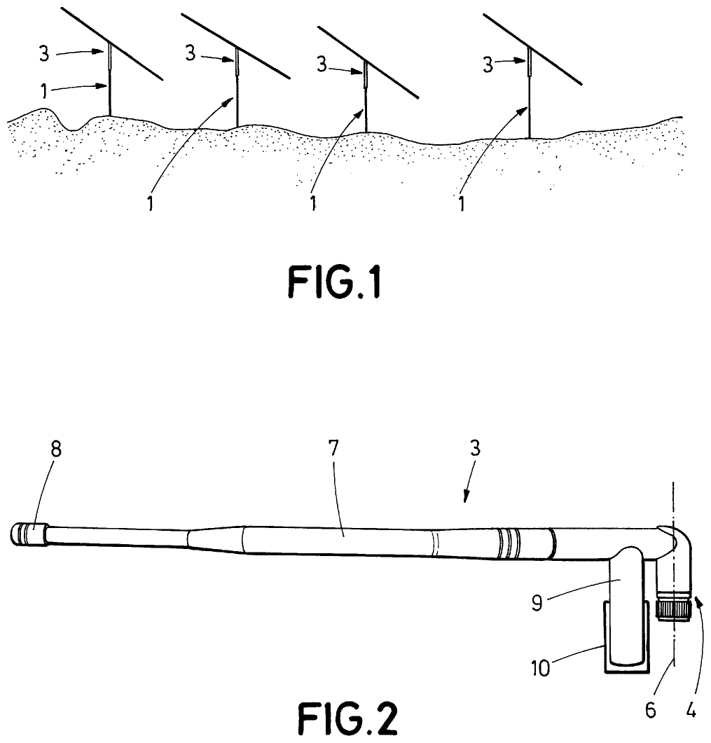

Next a detailed description of a preferred embodiment of the tracker controller of the invention shall be provided, with the help of FIGS. 1-4 mentioned above.

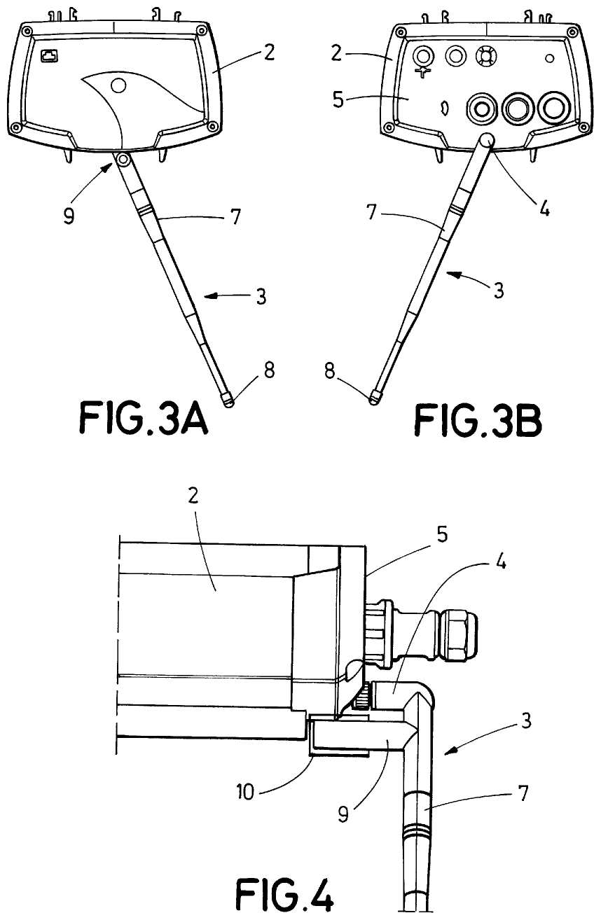

FIG. 1 schematically shows a photovoltaic installation comprising a plurality of solar trackers (1). Each solar tracker (1) comprises a tracking structure so as to support solar panels of the solar installation, and provide the solar panels with a tracking rotation for sun tracking, as is well known in the state of the art. The solar tracker (1) also comprises a tracker controller for controlling the tracking rotation and communicate the solar trackers (1) to each other. The tracker controller comprises a box (2), attached to the tracking structure, and a communications system housed within the box (2). At least one of the tracker controllers further comprises an external antenna (3) for the communications system, which is externally connected to the corresponding box (2), by a connection (4), at a lower portion of said box (2), preferably at a lower portion of a front or rear cover (5) of the box (2), see FIGS. 3B and 4, the antenna (3) being freely rotatable with respect to the box (2) around a rotation axis (6).

More particularly, as shown on FIG. 2, the antenna (3) comprises an elongated casing pipe (7), at one free end of which there is a tip (8) of the antenna (3), and wherein at an opposite end thereof there is the rotatory connection (4) which is angled, preferably right-angled, with respect to the casing pipe (7). The antenna (3) further comprises a protrusion (9), extending from the casing pipe (7) near the connection (4), and which is configured so as to bump with the box (2), when the antenna (3) rotates.

The free rotation of the antenna (3) with respect to the box (2), provided by the connection (4), together with the action of gravity, allows the antenna (3) to by default stay oriented along a vertical direction, the tip (8) of the antenna (3) pointing downwards, an therefore the connection (4) pointing upwards, irrespective of the position of the tracking structure, at least in absence of wind.

In conditions of strong wind, the wind makes the antenna (3) to rotate, by means of the connection (4), so that the antenna (3) adopts an inclined position, which may negatively affect performance of the antenna (3). However, as the protrusion (9) bumps against the box (2), rotation of the antenna (3) is limited, so that the antenna (3) does not deviate from the vertical orientation, on both directions of rotation, more than a predetermined amount which depends upon the position and the dimensions of the protrusion (9).

So that collision of the protrusion (9) against the box (2) does not cause damage to the antenna (3), the protrusion (9) may be provided with a bumper (10), such as a cover, made of a shock absorbing material, such as rubber or similar.

1.-7. (canceled)

8. A tracker controller for a photovoltaic installation, the tracker controller comprising:
a box intended to be attached to a tracking structure of a photovoltaic tracker of the installation;
a communications system housed within the box, intended to communicate the trackers to each other; and
an external antenna for the communications system, the antenna comprising:
an elongated casing pipe, and
a rotatory connection at one end of the casing pipe, externally connecting the casing pipe to a lower portion of the box, to allow the casing pipe to freely rotate with respect to the box around a rotation axis;
wherein the antenna further comprises a protrusion, extending from the casing pipe near the connection, and which is configured to bump with the box, when the antenna rotates, for limiting rotation of the casing pipe.

9. The tracker controller according to claim 8, wherein the connection is connected to a lower portion of a front or rear cover of the box.

10. The tracker controller according to claim 8, wherein the connection is angled with respect to the casing pipe.

11. The tracker controller according to claim 10, wherein the connection is right-angled with respect to the casing pipe.

12. The tracker controller according to claim 8, wherein the protrusion comprises a bumper made of a shock-absorbing material for protecting the antenna.

13. A solar tracker for a photovoltaic installation, the solar tracker comprising:
a tracking structure supporting solar panels and providing the solar panels with a tracking rotation for sun tracking;
the solar tracker being comprising a tracker controller for a photovoltaic installation, the tracker controller comprising:
a box intended to be attached to a tracking structure of a photovoltaic tracker of the installation;
a communications system housed within the box, intended to communicate the trackers to each other; and
an external antenna for the communications system, the antenna comprising:
an elongated casing pipe, and
a rotatory connection at one end of the casing pipe, externally connecting the casing pipe to a lower portion of the box, to allow the casing pipe to freely rotate with respect to the box around a rotation axis;
wherein the antenna further comprises a protrusion, extending from the casing pipe near the connection, and which is configured to bump with the box, when the antenna rotates, for limiting rotation of the casing pipe.

14. A photovoltaic installation comprising:
A solar tracker for a photovoltaic installation, the solar tracker comprising:
a tracking structure supporting solar panels and providing the solar panels with a tracking rotation for sun tracking;
the solar tracker being comprising a tracker controller for a photovoltaic installation, the tracker controller comprising:
a box intended to be attached to a tracking structure of a photovoltaic tracker of the installation;
a communications system housed within the box, intended to communicate the trackers to each other; and
an external antenna for the communications system, the antenna comprising:
an elongated casing pipe, and
a rotatory connection at one end of the casing pipe, externally connecting the casing pipe to a lower portion of the box, to allow the casing pipe to freely rotate with respect to the box around a rotation axis;
wherein the antenna further comprises a protrusion, extending from the casing pipe near the connection, and which is configured to bump with the box, when the antenna rotates, for limiting rotation of the casing pipe.
